(19) United States
(12) Patent Application Publication
(10) Pub. No.: US 2009/0126819 A1
(43) Pub. Date: May 21, 2009

(54) CLADDING FOR ELONGATE FLEXIBLE MEMBER

(75) Inventor: Richard Austin Beesley, Ormskirk Lancashire (GB)

Correspondence Address: BROOKS KUSHMAN P.C., 1000 TOWN CENTER, TWENTY-SECOND FLOOR, SOUTHFIELD, MI, 48075, US

(73) Assignee: TRELLEBORG CRP LIMITED, Stanley (GB)

(21) Appl. No.: 12/279,136

(22) PCT Filed: Feb. 9, 2007
(86) PCT No.: PCT/EP07/51286

§ 371 Date: Dec. 22, 2008

(30) Foreign Application Priority Data
Feb. 13, 2006 (GB) 0602827.8

(51) Int. Cl. F16L 11/18

(52) U.S. Cl. 138/106; 138/120; 138/110

(57) ABSTRACT

A cladding assembly for an elongate flexible member such as an underwater riser has a series of tubular buoyant sleeve members arranged end-to-end along the riser. The two ends of each buoyant member are formed into a part-spherical shape and are each received in a complementarily-shaped part-spherical socket in a securing collar. The buoyant sleeves are pivotable with respect to the securing collars, which allows the cladding assembly as a whole to flex with the riser.

The present invention relates to cladding for elongate flexible members. More particularly, but not exclusively, the invention relates to buoyancy devices for underwater cables, pipes and the like.

Flexible cables and pipes that pass from the seabed to the surface are supported with buoyancy modules. In particular, it is often desirable to form a pipe into a so-called “lazy S” or “lazy wave” before the final section of the pipe rises to a production platform. One way of achieving this is to use a number of individual buoyancy modules, each module being formed from two semi-cylindrical module portions secured together and being clamped to the pipe or cable with an internal integral clamp. However, many pipes (or risers, as they are often known) are heavily insulated. As a consequence, if individual buoyancy nodules were clamped to the exterior of the insulated riser the modules would tend to “creep” along the riser, as the insulation makes it difficult to clamp the modules securely in place.

In accordance with a first aspect of the present invention, there is provided a cladding assembly for an elongate flexible member, comprising a plurality of cladding members, each having a through aperture for passage of an elongate flexible member to be clad and a plurality of securing members, each securing member being engageable with one end of each of two cladding members, the engagement of the securing member with the cladding members permitting relative pivotal movement of the securing member and the cladding member to allow flexing of the cladding assembly.

Such an assembly can be located on a flexible member, for example an underwater riser. The assembly can then be held in position by means of two clamps, one located at either end of the assembly, which are fastened to a portion of the riser from which any insulation has been removed. Therefore, a very strong clamping engagement can be achieved which prevents creep of the assembly along the riser.

Preferably the cladding members are tubular and preferably they are also elongate.

Conveniently, the cladding members may be assembled from a plurality of sections, e.g. two sections. This facilitates locating the assembly around a riser or other elongate member.

Preferably, the cladding members comprise a sleeve member.

In one embodiment, the cladding members are buoyant. In particular, the cladding members may comprise a buoyant portion.

Preferably, the cladding members comprise enlarged end portions, each of which is engageable with a respective securing member. The enlarged end portions of each cladding member are preferably substantially identical.

In a preferred embodiment the enlarged end portions of the cladding member comprise a part-spherical portion and the securing members comprise two complementarily-shaped receiving sockets for receipt of a respective one of the two enlarged end portions of the cladding members.

Preferably, the receiving sockets in the securing members are part-spherical.

The securing means is preferably annular. In order to facilitate assembly, it is preferred the securing member is assembled from a plurality of sections, e.g. two sections.

Preferably, the securing member comprises a collar member.

By way of example only, a specific embodiment of the present invention will now be described, with reference to the accompanying drawings, in which:

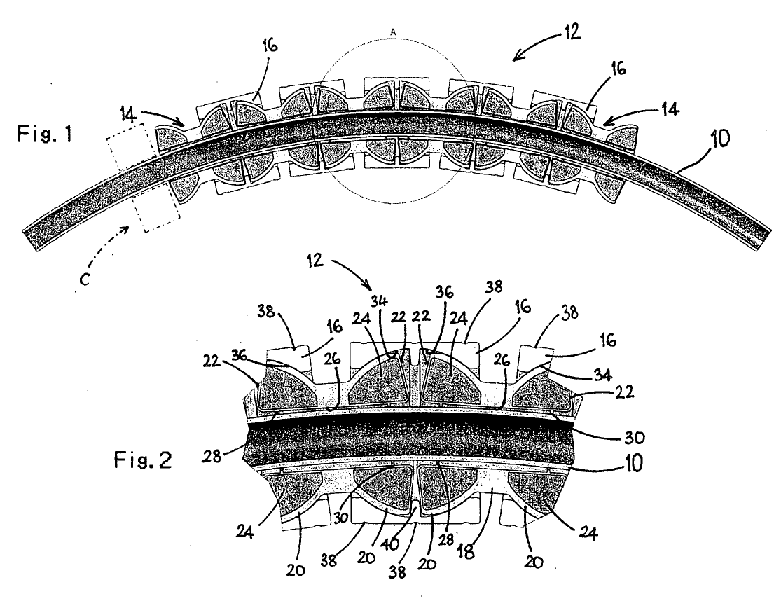

FIG. 1 is a longitudinal cross-section through an embodiment of cladding assembly in accordance with the present invention; and

FIG. 2 is a view of the portion within circle A of FIG. 1, shown to an enlarged scale.

An underwater pipe 10 is fitted along at least part of its length with a buoyant cladding assembly 12. The cladding assembly 12 comprises a plurality of identical elongate tubular buoyant sleeves 14 located along the length of the pipe 10, adjacent buoyant sleeves being maintained slightly spaced apart from each other, as will be explained. Adjacent ends of adjacent tubular buoyant members are secured in longitudinal position with respect to each other by means of one of a plurality of identical annular securing collars 16 which, as will be explained, secure adjacent sleeves together whilst also permitting flexing or annular displacement of adjacent buoyant members.

As best seen in FIG. 2, each tubular buoyant sleeve 14 is generally elongate and comprises a central cylindrical section 18 having a circular outer diameter and two end portions 20 whose outer surfaces are formed into an elongated head having a part-spherical shape. The end faces 22 of the tubular sleeve 14 are inclined away from the end faces 22 of the adjacent tubular buoyant sleeves to permit flexing of the assembly, as will be explained.

Each of the enlarged head portions 20 encloses an annular buoyant body 24 of syntactic foam. The outer surface of the head portions 20, together with the central cylindrical portion 18 are formed from polyurethane resin. A cylindrical through aperture 26 extends right through each tubular buoyant sleeve 14. The internal diameter of the cylindrical aperture 26 is arranged to exceed that of the pipe 10 onto which it is to be fitted, so that the cylindrical surface of the aperture does not, in use, contact the pipe. However, two inwardly directed annular ribs 28, 30 are provided on the cylindrical aperture, just longitudinally inward of a respective end of the buoyant sleeve, the internal diameter of the ribs 28, 30 being chosen to match, or slightly exceed, the outer diameter of the pipe onto which the assembly is to be fitted, so that only the ribs of the tubular cylindrical bodies engage the pipe.

For ease of assembly, each of the tubular buoyant sleeves 14 is formed in two semi-tubular sections which are subsequently assembled around the pipe 10 to be clad, as will be explained.

With reference to reference FIG. 2, each annular securing collar 16 comprises a generally cylindrical outer surface. However, the interior of the collar is provided with two part-spherical sockets 34, 36, each adapted to receive the enlarged head portion 20 of a respective one of two adjacent tubular buoyant sleeves 14. Each collar 16 is manufactured from polyurethane and, for ease of assembly, is formed in two semi-annular portions which are held together in use by clamping bands located in annular recesses 38 in the outer surface of the collar.

As best seen in FIG. 2, an internal inwardly-directed annular rib 40 separates the two part-spherical sockets 34, 36 and prevents the ends of adjacent tubular buoyant sleeves from contacting one another.

In use, the assembly 12 is fitted onto a pipe by assembling the two halves of a first tubular buoyant sleeve 14 on the pipe 10 adjacent to the two assembled halves of a second tubular buoyant sleeve 14 along the pipe. The two halves of a securing collar 16 are then assembled over the adjacent part-spherical ends of the two tubular buoyant sleeves 14, the part-spherical enlarged heads 20 of the tubular buoyant sleeves being received in the respective part-spherical sockets 34, 36 in the securing collar 16. The two halves of the collar 16 are then secured together by means of metal securing bands located in the annular recesses 38 in the outer surface of the collar 16.

Further tubular buoyant sleeves 14 are positioned along the pipe to be clad, with adjacent tubular buoyant sleeves being secured by means of a further collar 16 receiving the enlarged heads 20 of the tubular buoyant sleeves 14 in the respective part-spherical socket portions 34, 36. This procedure is repeated until the required length of cladding (corresponding to the required degree of buoyancy) is achieved, whereby the pipe passes through a substantially continuous passageway formed by the cylindrical apertures 26 of the tubular buoyant sleeves 14. At each end of the assembly 12, the insulation around the pipe 10 to be clad is stripped away, and a conventional annular clamp (illustrated schematically as C at the end of the assembly in FIG. 1) is securely fastened directly to the outer surface of the pipe 10 at each end of the assembly. In this way, the position of the assembly along the length of the pipe 10 is fixed.

As shown in the Figures, the receipt of the part-spherical enlarged heads 20 of adjacent tubular buoyant sleeves 14 in complementarily-shaped sockets 34, 36 in the collar 16 allows adjacent buoyant sleeves to flex or move angularly with respect to each other. In this way, the buoyancy assembly 12 as a whole can flex which in turn allows the pipe 10 to flex whilst still providing buoyancy. The inclined end faces 22 of the tubular buoyant sleeves 14 allows relative movement between adjacent tubular buoyant sleeves and indeed the degree of movement is defined by the degree of inclination of the end walls 22 of the tubular buoyant modules, since abutment of the end walls 22 with the inwardly directed annular rib 40 of the sleeve 16 which separates the two part-spherical sockets defines the maximum displacement of the tubular buoyant sleeves 14 with respect to its associated collar 16.

The invention is not restricted to the details of the foregoing embodiment. For example, although the tubular buoyant sleeves as described comprise buoyant syntactic foam this can be omitted. Indeed, the assembly can be made positively, negatively or neutrally buoyant, depending upon the selection of materials for construction. Moreover, although the invention has been described with reference to cladding of a flexible pipe, other elongate flexible members can be clad, for example underwater cables or “umbilicals”.

1. A cladding assembly for an elongate flexible member, comprising a plurality of cladding members, each having a through aperture for passage of an elongate flexible member to be clad and a plurality of securing members, each securing member being engageable with one end of each of two cladding members, the engagement of the securing member with the cladding members permitting relative pivotal movement of the securing member and the cladding member to allow flexing of the cladding assembly.

2. A cladding assembly as claimed in claim 1, wherein the cladding members are tubular.

3. A cladding assembly as claimed in claim 2, wherein the cladding members are elongate.

4. A cladding assembly as claimed in claim 1, wherein the cladding members are assembled from a plurality of sections.

5. A cladding assembly as claimed in claim 4, wherein the cladding members are assembled from two sections.

6. A cladding assembly as claimed in claim 1, wherein the cladding members comprise a sleeve member.

7. A cladding assembly as claimed in claim 1, wherein the cladding members are buoyant.

8. A cladding assembly as claimed in claim 7, wherein the cladding members comprise a buoyant portion.

9. A cladding assembly as claimed claim 1, wherein the cladding members comprise enlarged end portions, each of which is engageable with a respective securing member.

10. A cladding assembly as claimed in claim 9, wherein the enlarged end portions of each cladding member are substantially identical.

11. A cladding assembly as claimed in claim 9, wherein the enlarged end portions of the cladding member comprise a part-spherical portion and wherein the securing members comprise two complementarily-shaped receiving sockets for receipt of a respective one of the two enlarged end portions of the cladding members.

12. A cladding assembly as claimed in claim 11, wherein the receiving sockets in the securing members are part-spherical.

13. A cladding assembly as claimed in claim 1, wherein the securing means is annular.

14. A cladding assembly as claimed in claim 1, wherein the securing member is assembled from a plurality of sections.

15. A cladding assembly as claimed in claim 14, wherein the securing member is assembled from two sections.

16. A cladding assembly as claimed in claim 1, wherein the securing member comprises a collar member.

17. (canceled)
